(19) United States
(12) Patent Application Publication
(10) Pub. No.: US 2024/0428085 A1
(43) Pub. Date: Dec. 26, 2024

(54) ISOLATION FOREST WITH ULTRA-LOW RAM FOOTPRINT FOR EDGE

(71) Applicant: Telefonaktiebolaget LM Ericsson (publ), Stockholm (SE)

(72) Inventors: Prasanna CHALAPATHY, San Ramon, CA (US); Ashwin Kumar MURUGANANDAM, San Jose, CA (US); Anila JOSHI, Los Gatos, CA (US)

(21) Appl. No.: 18/699,297

(22) PCT Filed: Oct. 7, 2021
(86) PCT No.: PCT/IB2021/059223

§ 371 Date: Apr. 7, 2024

(51) Int. Cl. G06N 5/01

(52) U.S. Cl. CPC G06N 5/01

(57) ABSTRACT

A method and system for generating a prediction in a low resource device using a decision tree based machine learning model includes receiving input for a prediction request, selecting a first tree from the machine learning model, selecting and loading a first node from the first tree into working memory, accumulating a result from the first node, releasing the first node from working memory, and selecting and loading a second node from the first tree into working memory.

### TECHNICAL FIELD

Embodiments of the invention relate to the field of memory management and artificial intelligence; and more specifically, to a method and system for executing artificial intelligence applications with limited memory storage resources.

### BACKGROUND ART

Machine learning (ML) algorithms can be deployed in telecommunication networks for various purposes including managing the operations of the telecommunications networks. In some cases, ML algorithms can be deployed at the ‘edge’ of these telecommunication networks. The computing resources at the edge (e.g., at base stations) can be limited. Due partially to the limited resources, the operation of edge devices is often driven by the need to deploy highly optimized and efficient systems at the edge. Due to the large data sets required to create accurate ML models, and the large amount of computing power required to train ML models, training of ML models is usually performed offline either in a cloud or high-performance computing environment. In contrast, the run time operation of trained ML models (e.g., performing inference) can take place at the edge.

Considering edge devices are constrained environments in terms of compute and storage resources (e.g., central processing unit (CPU) and random access memory (RAM) availability), it is critical that ML solutions that operate in these constrained environments use the resources efficiently. When it comes to efficient use of RAM, it is important that a given ML solution uses as little RAM as possible and work within predefined budget of RAM allocated for the ML solution. Unlike a typical software feature, the ML solution requires periodic upgrades to the ML model to counter drifts (i.e., changes in the operating conditions), which means an ML solution that initially meets the RAM requirements at deployment could exceed these RAM requirements after multiple updates of the models in the ML solution. These constraints make it hard to deploy and maintain a ML solution at an edge of a telecommunications network.

### SUMMARY

In one embodiment, a method for generating a prediction in a low resource device using a decision tree based machine learning model includes receiving input for a prediction request, selecting a first tree from the machine learning model, selecting and loading a first node from the first tree into working memory, accumulating a result from the first node, releasing the first node from working memory, and selecting and loading a second node from the first tree into working memory.

In another embodiment, a non-transitory machine-readable medium includes computer program code which when executed by a computer carries out a set of operations of a method for generating a prediction in a low resource device using a decision tree based machine learning model, where the set of operations include receiving input for a prediction request, selecting a first tree from the machine learning model, selecting and loading a first node from the first tree into working memory, accumulating a result from the first node, releasing the first node from working memory, and selecting and loading a second node from the first tree into working memory.

In a further embodiment, an electronic device includes a machine-readable medium having stored therein an anomaly detector, and a processor coupled to the machine-readable medium. The processor is to execute the anomaly detector to perform a method for generating a prediction in a low resource device using a decision tree based machine learning model. The anomaly detector is to receive input for a prediction request, select a first tree from the machine learning model, select and load a first node from the first tree into working memory, accumulate a result from the first node, release the first node from working memory, and select and load a second node from the first tree into working memory.

In one embodiment, an electronic device executes a plurality of virtual machines supporting network function virtualization (NFV), the electronic device includes a machine-readable medium having stored therein an anomaly detector, and a processor coupled to the machine-readable medium. The processor executes the plurality of virtual machines. At least one of the plurality of virtual machines executes an anomaly detector to perform a method for generating a prediction in a low resource device using a decision tree based machine learning model, the anomaly detector to receive input for a prediction request, select a first tree from the machine learning model, select and load a first node from the first tree into working memory, accumulate a result from the first node, release the first node from working memory, and select and load a second node from the first tree into working memory.

### BRIEF DESCRIPTION OF THE DRAWINGS

The invention may best be understood by referring to the following description and accompanying drawings that are used to illustrate embodiments of the invention. In the drawings:

FIG. 1 is a diagram of one embodiment of a process for executing an isolation forest model.

FIG. 2 is a flowchart of one embodiment of a process for determining the path length for a decision tree in the isolation forest model.

FIG. 3 is a diagram of one embodiment of a system for generating a decision tree based ML model.

FIG. 4 is a diagram of one embodiment of a prediction process using a trained decision tree based ML model.

FIG. 5 is a diagram of one example of the structure of a trained model.

FIG. 6 is a diagram of a first example serialized decision tree.

FIG. 7 is a diagram of a second serialized example decision tree.

FIG. 8 is a diagram of a third serialized example decision tree.

FIG. 9 is a diagram of a fourth serialized example decision tree.

FIG. 10 is a diagram of a fifth serialized example decision tree.

FIG. 11 is a flowchart of one embodiment of the process of the prediction system utilizing the trained ML model.

FIG. 12 is a flowchart of one embodiment of the predict function.

FIG. 13 is a flowchart of one embodiment of a modelComputeResult function.

FIG. 14 is a flowchart of one embodiment of a function to travers a decision tree to a left child node.

FIG. 15 is a flowchart of one embodiment of a function to travers a decision tree to a right child node.

FIG. 16 is a diagram of a function for comparing data at nodes in the decision trees.

FIG. 17A illustrates connectivity between network devices (NDs) within an exemplary network, as well as three exemplary implementations of the NDs, according to some embodiments of the invention.

FIG. 17B illustrates an exemplary way to implement a special-purpose network device according to some embodiments of the invention.

FIG. 17C illustrates various exemplary ways in which virtual network elements (VNEs) may be coupled according to some embodiments of the invention.

FIG. 17D illustrates a network with a single network element (NE) on each of the NDs, and within this straightforward approach contrasts a traditional distributed approach (commonly used by traditional routers) with a centralized approach for maintaining reachability and forwarding information (also called network control), according to some embodiments of the invention.

FIG. 17E illustrates the simple case of where each of the NDs implements a single NE, but a centralized control plane has abstracted multiple of the NEs in different NDs into (to represent) a single NE in one of the virtual network(s), according to some embodiments of the invention.

FIG. 17F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 18 illustrates a general purpose control plane device with centralized control plane (CCP) software 1850), according to some embodiments of the invention.

### DETAILED DESCRIPTION

The following description describes methods and apparatus for executing machine learning (ML) algorithms in low computing resource and memory constrained environments. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

The embodiments provide a method to tackle the memory storage and computing resource constraints for executing ML algorithms. In particular, the embodiments can enable the execution of the ML algorithm called the Isolation Forest algorithm and similar decision tree based ML algorithms that can be used for anomaly detection at edge computing devices. The embodiments are described in relation to the use of an isolation forest algorithm by way of example and not limitation. Those skilled in the art would appreciate that other similar ML algorithms can also be implemented consistent with the principles and structures described herein. Isolation forest is a machine learning algorithm that can be utilized for anomaly detection or similar applications in a telecommunications network. The isolation forest algorithm is an unsupervised learning algorithm that can be utilized, for example, to identify anomalies by isolating outliers in the input data of monitored conditions in the telecommunication network. An isolation forest algorithm is similar to a random forests algorithm and is built based on an ensemble of decision trees for a given dataset. The isolation forest algorithm can be used to identify anomalies based on input data with short average path lengths when traversing the isolation trees.

In an ML solution based on the isolation forest algorithm, an ML model is trained with a large dataset and tuned with hyper parameters such as a number of trees, sample size, and similar hyper parameters. For use in edge devices, the ML model is trained offline, and inference is performed on a live node (i.e., at an edge device). Inference predominantly involves finding a path length in each tree in the ML model for a given input inference data and computing the anomaly score based on the average path lengths. A Path Length h(x) of a point x is measured by the number of edges x traverses a tree from the root node until the traversal is terminated at an external node.

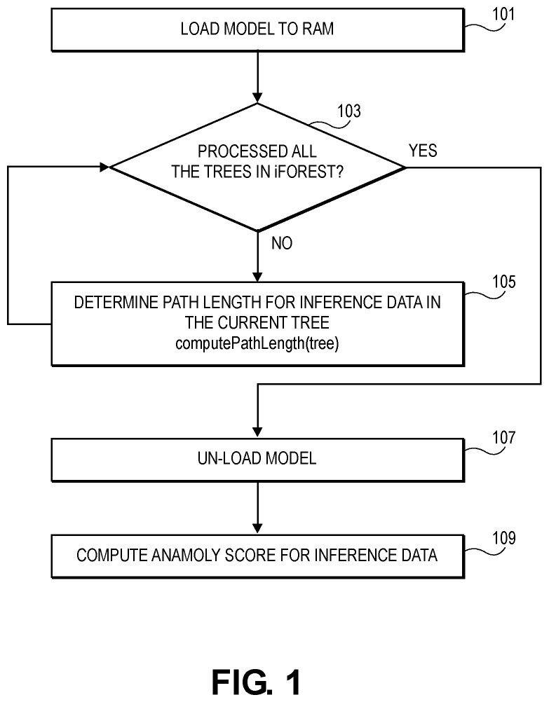

FIG. 1 is a diagram of one embodiment of a process for executing an isolation forest model. The process can initialize by loading the entire isolation forest model into working memory (e.g., RAM) (Block 101). The isolation forest model can be composed of any number of decision trees, generally a large number of decision trees. A check is made whether each of the decision trees in the model have been processed (Block 103). After initial loading this check would be negative in which case the input (i.e., inference) data is applied to the decision tree to reach a leaf of the decision tree and based on this result a path length for the decision tree is computed (Block 105). This process is repeated for each of the decision trees in the model until all of the decision trees are processed (Block 103). At the point that the decision trees have each been processed the isolation forest model can be unloaded from the memory storage (Block 107). An anomaly score can be computed for the input (inference data) to determine whether there was an anomaly in the input data. In this example embodiment, the entire isolation forest model is loaded and processed before it is unloaded. In other embodiments, one decision tree at a time can be loaded instead of loading the whole isolation tree model.

As used herein a “working memory” is a region of non-persistent storage (e.g., RAM) that is utilized at the application level to perform functions and operations of a program that is executing. The “working memory” as used herein is exclusive of caching structures and long term, persistent, and higher latency storage. The long term, persistent, and higher latency storage is a storage device such as a solid state drive, optical drive, magnetic drive, or similar electronic device on which program code and data may be stored, but which is not utilized by the operating system or memory management system of the device for the active execution of programs and their functions.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

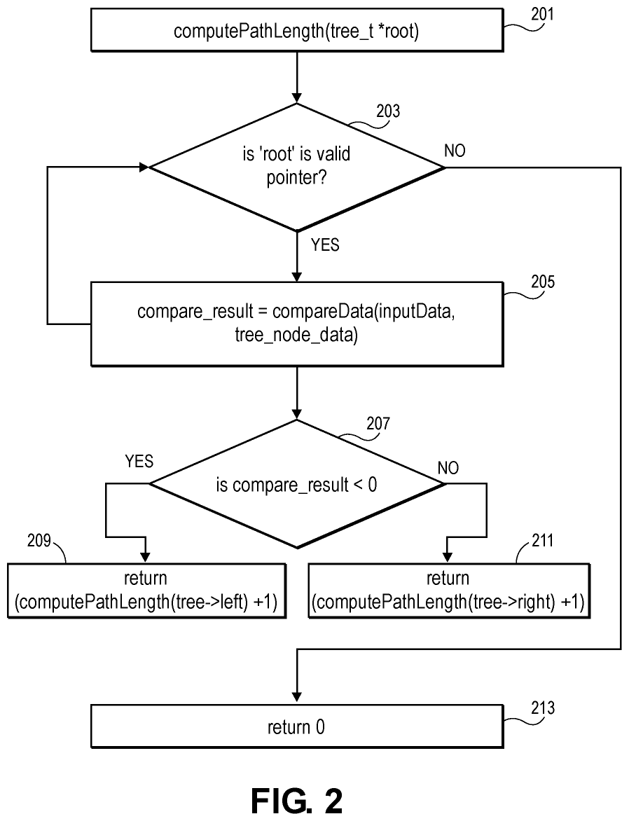

FIG. 2 is a flowchart of one embodiment of a process for determining the path length for a decision tree in the isolation forest model. Determining the path length can be initiated by a call to the path length computation function that includes the tree root identifier or pointer (Block 201). The identifier or root validity can be checked (Block 203), and where invalid an error, null, or zero value can be returned (Block 213). Where the root is valid, a comparison of the current node in the decision tree and the input data for the inference process are compared (Block 205). Where the result of the comparison is less than zero then the process can traverse the decision tree to the next node to the ‘left’ and add one to the path length (Block 209), whereas if the comparison result is greater than zero then the process can traverse the decision tree to the next node to the ‘right’ and add one to the path length (Block 211). The decision trees are binary; thus, the comparison guides a decision to descend on one of two paths. The process is recursive and once all of the function calls return the path length is inherently computed. This process can require the entire decision tree to be in working memory (e.g., RAM).

The embodiments address problems of existing technology. The existing technology involves building a forest (i.e., a group of decision trees) in RAM and developing an application programming interface (API) to traverse all the trees in the forest to arrive at an anomaly score for a given inference input. The major problem with current technologies is a need for a large amount of working memory (e.g., RAM) at the device executing the isolation forest model. For a typical isolation forest model, the working memory requirement depending on the training dataset size and other hyper parameters, can range from ˜100 megabytes (MBs) to 200 MBs. This amount of memory usage is difficult to support at edge devices such as radio baseband units. There may not be enough working memory at the edge devices to allot ˜100 MB-200 MB. Even if there is sufficient working memory to allot, e.g., 100 MB to 200 MB RAM for an isolation forest model, it will be at the expense of existing features or it will hinder addition of new features in the future for lack of sufficient working memory. The working memory requirements needs to be addressed for every new model or update to the model delivered during life cycle of the ML solution. This again increases the burden of managing the ML model on embedded systems.

The embodiments provide a process and system that minimizes the working memory requirements for executing the ML model. Further, the working memory requirement does not significantly change even when new versions of models are delivered during the life cycle of an ML solution that utilizes the ML model.

The embodiments remove the need to build trees in working memory instead the embodiment provide a traversal algorithm that reads only one node at a time from the ML model, the process predicts input against that node, and then reads the next node (either left or right) depending on outcome of the prediction. With this solution, the working memory requirement is equal to the size of a tree node (e.g., about 32 bytes), which is significantly less than a typical solution (i.e., 100 MB-200 MB) and is static for every new model created.

The embodiments encompass a unique tree traversal algorithm that traverses each tree without creating/extracting the entire tree from the ML model into working memory, and instead the process extracts just one node of a tree at a time from the ML model Thereby using the minimal amount of working memory and a constant amount of working memory to perform inference using a decision tree (e.g., isolation forest) based model on low resource systems such as embedded or edge device systems. The proposed solution addresses two biggest challenges in using isolation forest models in embedded systems.

The embodiments provide advantages over the art. The embodiments have a minimal working memory requirement. Systems with low or limited resources (e.g., edge systems or embedded systems) and the embodiments enable other features to be utilized since they consume a minimum amount of working memory. A typical AI/ML model based on isolation forest models would need around ˜100 MB-200 MB of working memory, whereas the embodiments reduce the working memory requirement for the same AI/ML model to around 32 bytes during execution. Further, the embodiments provide a process where a fixed amount of working memory are utilized during the AI/ML model life cycle. In a typical AI/ML model life cycle, new or updated models need to be delivered to handle concept drift scenarios and as the new or updated models are delivered the RAM requirement should continue to be within same range as the previous models. This requirement can be hard to meet as the size of model is dependent many factors training data size and hyper parameters (for example, number of trees, sample size for an isolation forest model). The embodiments remove such constraint on model development, as every model will consume a fixed or restricted amount of working memory. The embodiments also do not impact the accuracy of the ML model in anyway, as the embodiments do not involve significant changes in the training phase of the ML model.

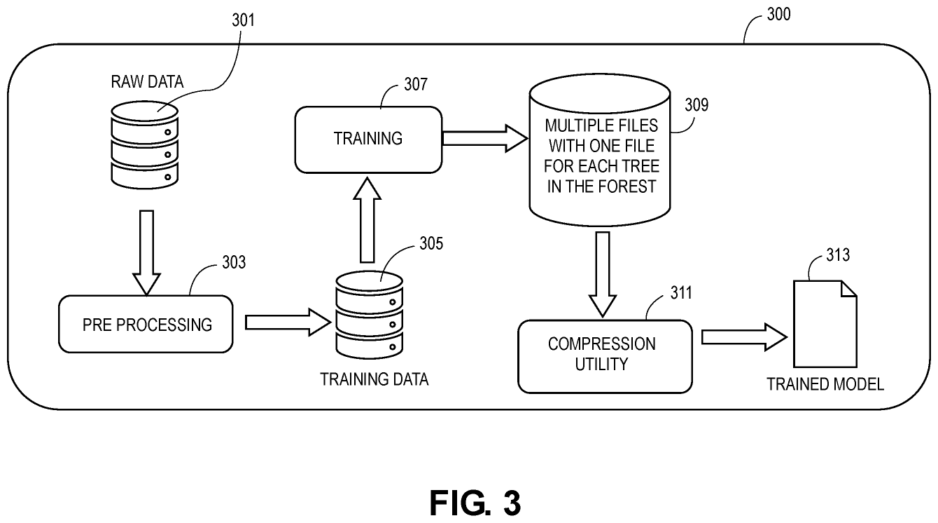

FIG. 3 is a diagram of one embodiment of a system for generating a decision tree based ML model. In particular the example system 300 is a system for the off-line training of a ML model (e.g., a decision tree based ML model). In the example system, a set of raw data 301 representative of the system being modeled. For example, if the operation of an edge device in a mobile telecommunication network is being modeled then the raw data can include metrics and operational status information collected from a set of representative edge devices. This raw data 301 can be pre-processed 303 to normalize and similarly organize the data into training data 305. The training data 305 can then be utilized for the training phase 307 of an ML model (e.g., an isolation forest model).

The training phase 307 produces multiple files or data structures with one file or data structure for each decision tree in the isolation forest model 309. These files and/or data structures can be compressed by a compression utility 311 into a format of a trained model 313. Any compression scheme or algorithm can be utilized on the files and/or data structures 309. The trained model 313 can be distributed to be executed by any execution engine such as an AI execution engine at an edge device.

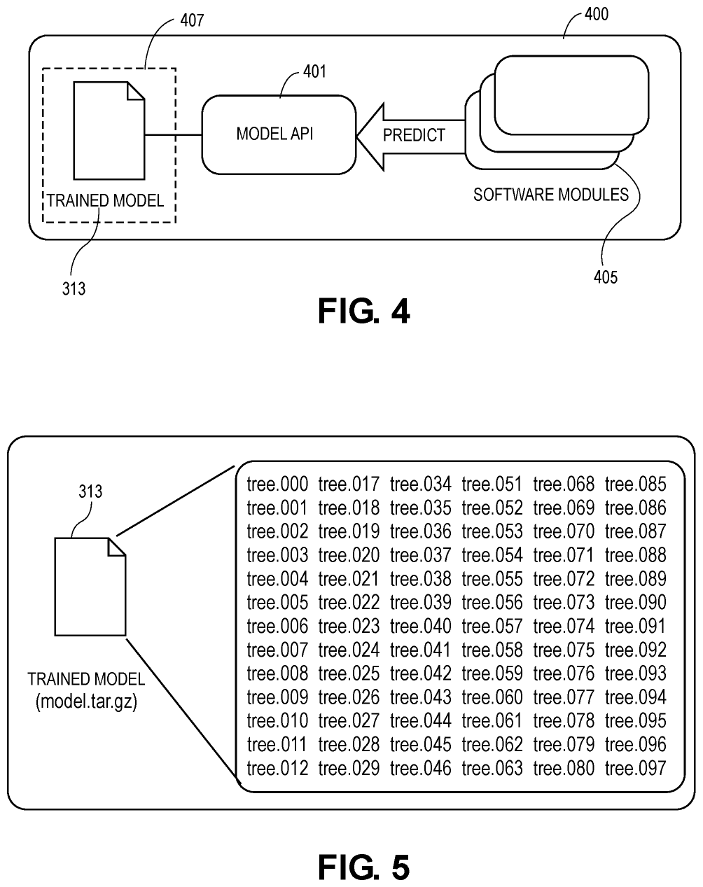

FIG. 4 is a diagram of one embodiment of a prediction process using a trained decision tree based ML model. The trained model 313 can be utilized as part of an integration and prediction system of an online edge device, embedded system, or similar system 400. The system 400 can include a set of software modules 405 that make use of the trained model 313. The software modules 405 can be any function or application that can request a prediction from the trained model 313.

The software modules 405 can request the prediction via a model application programming interface 401 or similar interface that enables calls directly to the trained model 313 or to an AI model execution engine 407 that executes the trained model 313. Any AI execution engine 407 and model API 401 can be utilized by the system 400 to enable the use of predictions from the trained model 313 by the software module 405. While a single trained model 313 is shown, any number of trained models 313 can be installed and accessible in the system 400 via the model API 401 or separate model APIs.

The embodiments improve the operation of at least the trained model 313 and the model API 401. The embodiments construct the trained models 313 in a way to support traversal of the decision trees without building the entire decision tree at any given time. The embodiments implement a unique predict/inference model API that traverses the tree to generate a prediction without building the entire tree in the working memory (e.g., RAM).

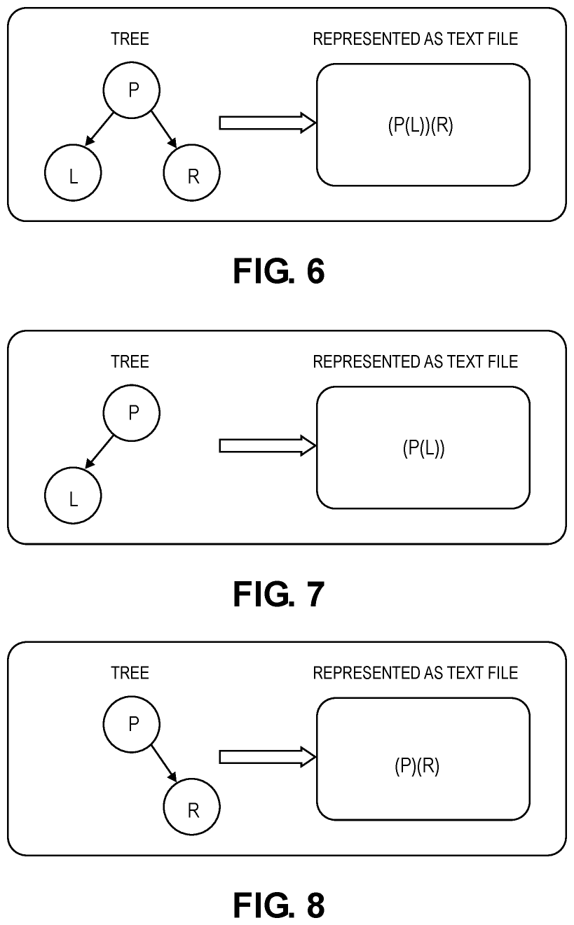

FIG. 5 is a diagram of one example of the structure of a trained model. In this example the trained model 313 is compressed using the tar function and gzip functions from Unix or MacOS operating systems. The trained model 313 consists of multiple files one file for each decision tree (e.g., each decision tree in the isolation forest). In the illustrated example, a set of decision trees named tree.000 to tree.099 are included in the trained model 313 (named in this example model.tar.gz). Each of the files in the trained model 313 includes a separate serialized decision tree. Examples of the serialize decision trees are shown in reference to FIGS. 6 through 10.

FIG. 6 is a diagram of a first example serialized decision tree. The example decision trees are simplified for sake of clarity and conciseness. One skilled in the art would appreciate that the decision trees could be significantly longer taking up many megabytes of storage space each. In the example of FIG. 6, a decision tree with three nodes and the textual representation as it may be recorded in the file.

Each decision tree is constructed by splitting the sub-sample points/instances of the training data over a split value of a randomly selected attribute such that the instances whose corresponding attribute value is smaller than the split value goes left and the others go right, and the process is continued recursively until the tree is fully constructed. The split value is selected at random between the minimum and maximum values of the selected attribute.

There are two types of nodes in the decision tree an internal node and an external node. Internal nodes are non-leaf and contain the split value, split attribute, and pointers to two child sub-trees. An internal node is always a parent (P) to two child sub-trees making the entire decision tree a proper binary tree. External nodes are leaf nodes (left (L) or right (R) that could not be split further and reside at the bottom of the tree. Each external node will hold the size of the un-built subtree which is used to calculate the anomaly score.

In the trained model, each file contains a serialized tree, for example as demonstrated with FIG. 6-10. In the example of FIG. 6, the decision tree has one parent node (P) and two leaf nodes (L, R) and is represented in serialized text as (P(L))(R).

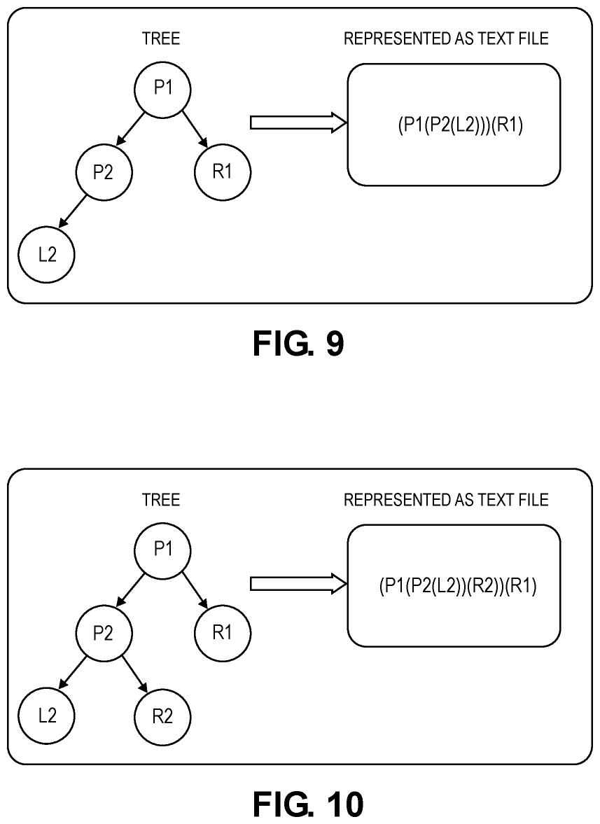

FIG. 7 is a diagram of a second serialized example decision tree. The example decision tree of FIG. 7 includes only a patent node (P) and a single leaf (L), which is represented as (P(L)) in the decision tree file. FIG. 8 is a diagram of a third serialized example decision tree. The example decision tree of FIG. 8 includes a single parent node (P) and a single leaf (R) and is represented in serialized text as (P)(R). FIG. 9 is a diagram of a fourth serialized example decision tree. The example decision tree of FIG. 9 includes four nodes including two internal parent nodes (P1 and P2) and two external leaf nodes (R1 and L2). This decision tree is represented as (P1(P2(L2)))(R1) in serialized text. FIG. 10 is a diagram of a fifth serialized example decision tree. The example decision tree of FIG. 10 includes five nodes including two internal parent nodes (P1 and P2) and three external leaf nodes (R1, R2 and L2). This decision tree is represented as (P1(P2(L2))(R2))(R1) in serialized text.

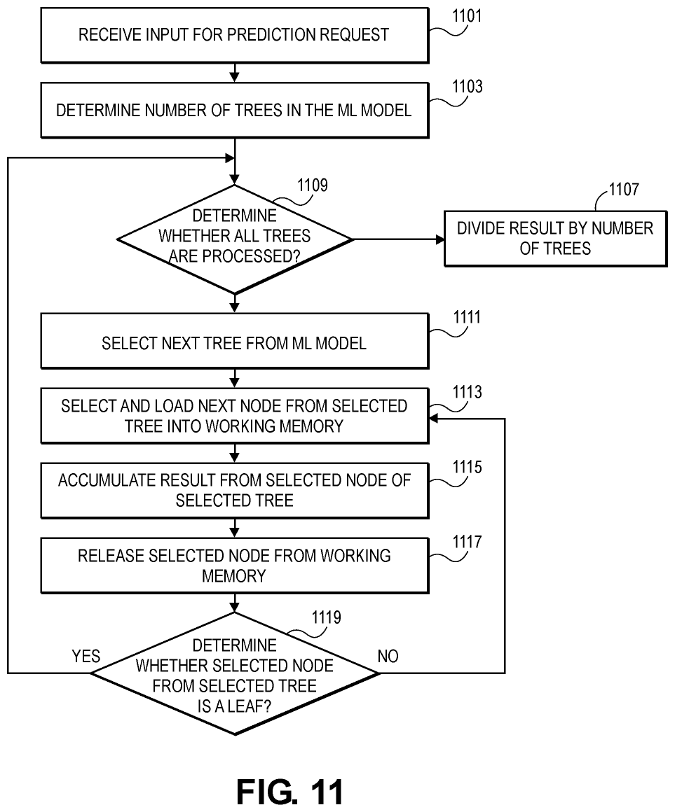

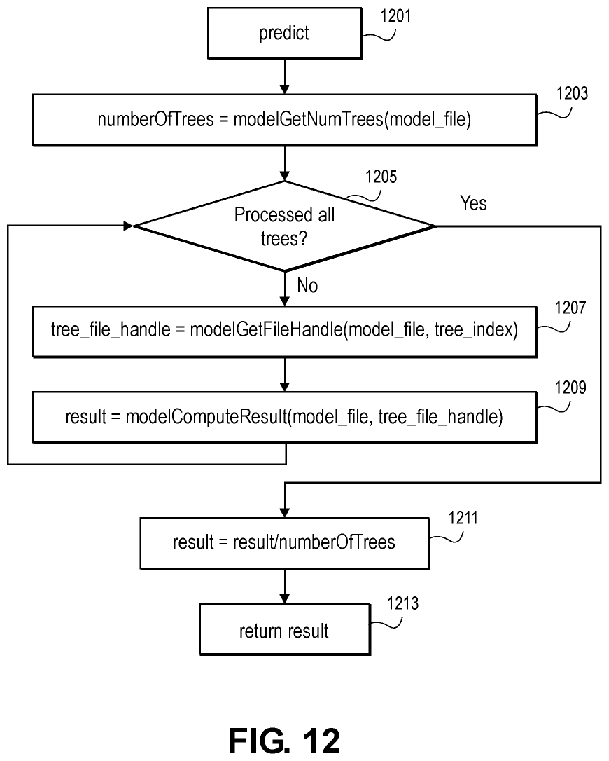

FIG. 11 is a flowchart of one embodiment of the process of the prediction system utilizing the trained ML model. The process of FIG. 11 is a general representation of the process. Example implementations of the process are further discussed herein with relation to FIGS. 12 through 16. The process of the prediction system can be initiated or triggered when a request for a prediction using the trained model is received (Block 1101). The request can be received via a model API or similar interface from any source (e.g., a software module of an edge device executing the prediction system). The trained model can be accessed to determine a number of trees that are in the trained model (Block 1103). The count of the trees can be determined by adding up the number of files, by retrieving the information from metadata for the trained model, or by a similar mechanism.

The process will then iterate through each of the trees to arrive at a prediction. A check is made in each iteration whether additional trees remain to be processed (Block 1109). In some embodiments, where the trees are accessed sequentially a check for the next tree in the sequence can be made. In other embodiments, the prediction system can track those decision trees that have been processed or not processed in a tracking structure, such as a list, array, or similar mechanism. If all of the decision trees have been processed, then an accumulated result of processing all of the decision trees can then be divided by the number of decision trees to arrive at a prediction, or a metric correlated with the prediction.

If further decision trees remain to be processed, then the next decision tree from the trained ML model is selected (Block 1111). The decision trees can be selected in any order. In some embodiments, parallel processing of some of the decision trees can be utilized depending on the working memory constraints of the executing system. Using the selected decision tree, the next node in the decision tree is selected and loaded into working memory (Block 1113). The process only requests that a single node from the decision tree be loaded. However, the underlying memory management system or operating system may load more than the requested node into working memory or cache. However, any additional nodes that are loaded into working memory or caches (i.e., from long term, persistent, and higher latency storage) will be based on spatial locality, cache or working memory space, and similar constraints outside that can efficiently manage the bandwidth of loading from the long term, persistent, and higher latency storage. The single node is then evaluated, and a result is added to an accumulated value that is being generated by the process across all of the decision trees that are evaluated (Block 1115). Once the selected node has been evaluated, then the selected node can be released from the working memory (Block 1117). Releasing the selected node from working memory may not remove the selected node from working memory. The operating system, memory management system, or other components can evict the selected node after it is released where the space in working memory is needed.

Once the selected node is processed and/or released, then the prediction process can determine whether the selected node is a leaf (Block 1119). If the selected node is a leaf, then the traversal of the selected decision tree has completed, and the next decision tree can be selected where further decision trees remain to be processed (Block 1109). If the selected node is not a leaf, then the process can select a next node based on the evaluate of the selected node. Where the decision tree is a binary tree, the decision is made to traverse the decision tree to the left or right in the decision tree and thereby select and load a next node from the selected decision tree into the working memory (Block 1113). The process continues in this fashion until all of the decision trees and node in those trees have been traversed and the result arrived at in Block 1107 that provides a metric that can be returned as a prediction.

In some embodiments, the prediction process can be accessed and implemented via a model API. Where prediction is needed software modules can invoke the model API passing the input data to the trained model. The model API can perform any necessary pre-processing of the input data. In some cases, the prediction system is a part of the model API, which then traverses each tree in the trained model (e.g., an isolation forest) to determine the result to be returned. The model API can be designed in such a way that at any point of time, RAM for only one tree node is allocated.

FIGS. 12 through 16 provide example implementations of functions used in some example embodiments, including predict, modelComputeResult, treeMoveToLeft, and treeMoveToRight functions. FIG. 12 is a flowchart of one embodiment of the predict function. The predict function can be initiated by a call to the predict function of the model API (Block 1201). The predict function can determine a ‘numberOfTrees’ by using a modelGetNumTrees function that takes a ML model as an input (‘model_file’). The function then determines whether all of the trees in the model have been processed. If all of the trees have been processed, then a result is computed by dividing a current value of the accumulated ‘result’ by the determined number of trees (numberOfTrees) (Block 1211). This ‘result’ is then returned to the caller (Block 1213).

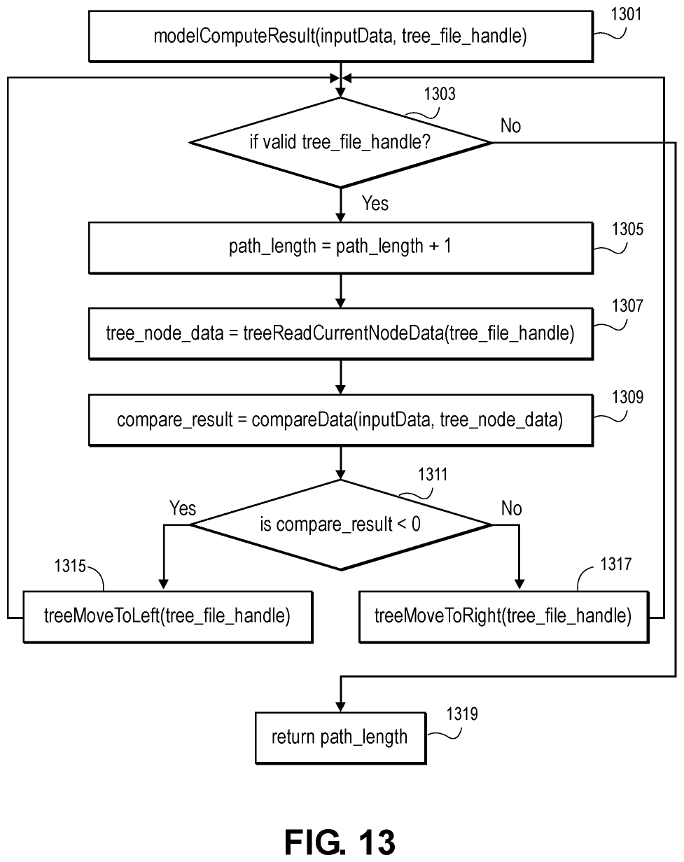

If all of the trees have not been processed, then a next tree is determined using a modelGetFileHandle function that takes the ML model (model_file) and an index (tree_index) to determine or identify the next tree (Block 1207). An accumulated ‘result’ is determined for the selected tree by calling the modelComputeResult function, discussed further herein with relation to FIG. 13. The modelComputeResult function takes the ML model (model_file) and tree identifier (tree_file_handle) as inputs (Block 1209). The process continues to iterate through the trees of the ML model until they are all processed, and the result is returned (Block 1213).

FIG. 13 is a flowchart of one embodiment of a modelComputeResult function. In the example flowchart, the function is called and passed an ML model (inputData) and tree identifier (tree_file_handle) (Block 1301). A check is made whether the tree identifier (tree_file_handle) is valid (Block 1303). If the tree identifier is not valid then the current path_length (e.g., 0) is returned and the process completes.

If the tree identifier is valid, then the path length is incremented by one indicating that the traversal of the tree has gone one level deeper (Block 1305). The current node in the tree is then retrieved by the treeReadCurrentNodeDate function which takes the tree_file_handle that identifies the current tree (Block 1307). The current node is assigned to the tree_node_data label. A compare result function (compareData) operates on the input data (inputData) and the tree_node_data (i.e., the current node in the selected tree) (Block 1309). The result (compare_result) indicates whether the tree is to be traversed to the left or the right child node of the current node being evaluated (Block 1311). If the result is less than zero then the left node is selected (Block 1315), whereas if the result is greater than or equal to zero then the right node is selected (Block 1317).

Traversal of the tree to the left (Block 1315) can be initiated by the treeMoveToLeft function that takes the current tree identifier (tree_file_handle) and initiates the traversal of the decision tree from the selected node to the left child node. Traversal of the tree to the right (Block 1317) can be initiated by the treeMoveToRight function that takes the current tree identifier (tree_file_handle) and initiates the traversal of the decision tree from the selected node to the right child node. The modelComputeResult function can continue to iterate until the nodes of the tree have been processed.

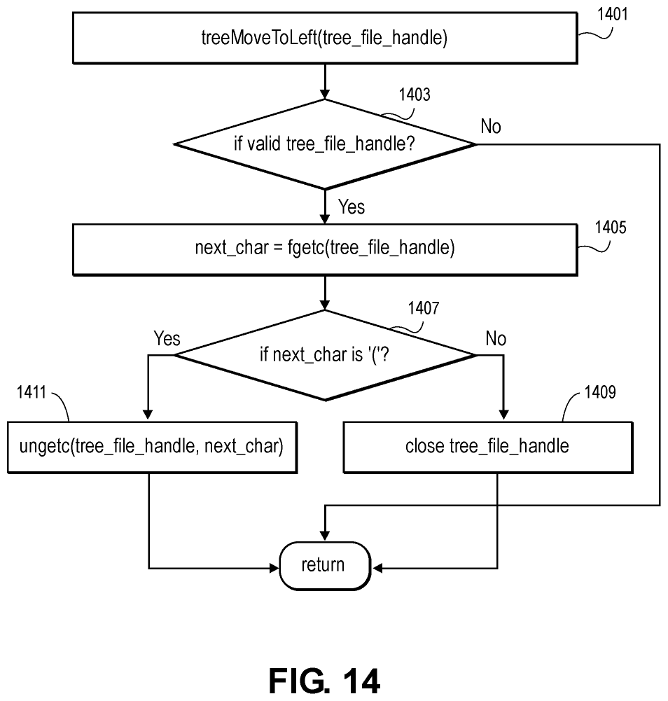

FIG. 14 is a flowchart of one embodiment of a function to travers a decision tree to a left child node. This function can be a part of the model API, an AI execution engine, or similar software. The function can be called by modelComputeResult function or similar functions. The process of the treeMoveToLeft function can be provided an identifier for the current decision tree being reversed (tree_file_handle) (Block 1401). A check is made whether the identifier is valid (Block 1403). The next character in the serial representation of the decision tree is then retrieved and labeled next_char (Block 1405). If the identifier isn't valid then the process returns to the calling function. A check is made whether the next_char is a left parenthesis‘(’ (Block 1407). If the next character is a left parenthesis, then this character can be released (Block 1411) lining up the serial representation with the left child to be consumed next before returning to the calling function. If, however, the next_char is not a left parenthesis, then the current node is a leaf, and the traversal of the tree has completed. Thus, the tree can be closed (Block 1409) before returning to the calling function that will then select the next tree.

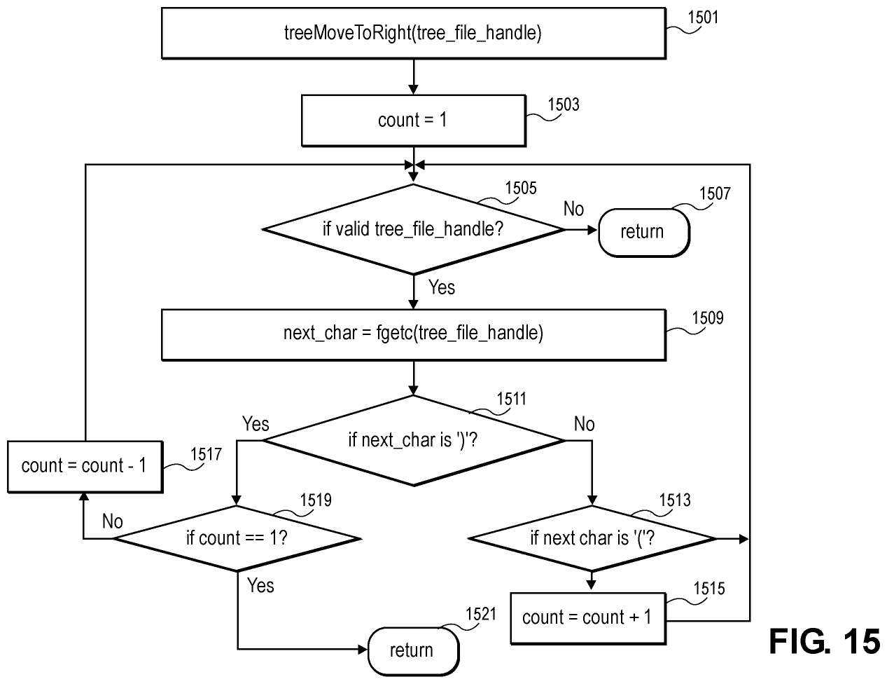

FIG. 15 is a flowchart of one embodiment of a function to travers a decision tree to a right child node. This function can be a part of the model API, an AI execution engine, or similar software. The function can be called by modelComputeResult function or similar functions. The process of the treeMoveToRight function can be provided an identifier for the current decision tree being reversed (tree_file_handle) (Block 1501). A count is initialized for this process as count=1 (Block 1503). A check is made whether the identifier is valid (Block 1505). If the identifier isn't valid then the process returns to the calling function (Block 1507). The next character in the serial representation of the decision tree is then retrieved and labeled next_char (Block 1509). A check is made whether the next_char is a right parenthesis‘)’ (Block 1511). If the next character is a right parenthesis, then a check is made whether the count is equal to 1 (Block 1519).

If the next char is a right parenthesis and the count is equal to 1, then the process returns to the calling function having lined up the serial representation with the next right child node. If the count is not equal to 1, then the count is decremented (Block 1517) and the next character is retrieved (Block 1509) if the tree is still valid (Block 1505). If the next_char (Block 1511) is not a right parenthesis, then a check is made whether the next_char is a left parenthesis (Block 1513). If the next_char is a left parenthesis then the count in incremented (Block 1515) before the validity of the tree is checked (Block 1505) and the next character selected (Block 1509). This process continues until it lines up the serial representation with the right child to be consumed next before returning to the calling function.

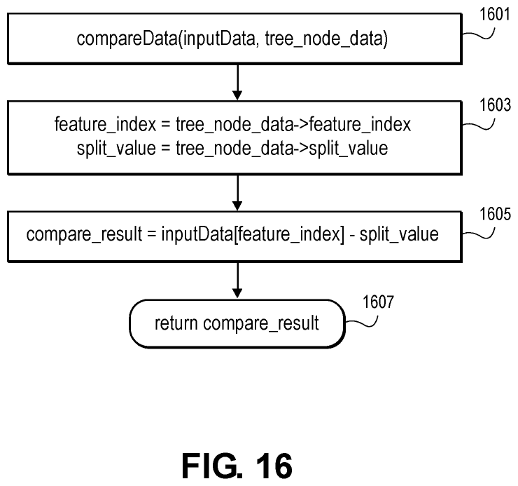

FIG. 16 is a diagram of a function for comparing data at nodes in the decision trees. This function can be a part of the model API, an AI execution engine, or similar software. The function can be called by modelComputeResult function or similar functions. The compareData function can receive input data and a current node data (Block 1601). A feature index (feature_index) and split value (split_value) are determined from the current node data (Block 1603). The input data is then applied to the feature index and split value to determine the compare result (compare_result) (Block 1605), which is returned to the calling function (Block 1607).

The embodiments can be further enhanced to load more than one node of a tree at a time. For example, a given edge device target can specify the amount of working memory (e.g., RAM) that can be used by the model and the solution can load more than one node (possibly a part of tree) within specified memory limits. This would minimize frequent secondary memory access on the device.

### EXAMPLE

Size of Isolation Forest Model—This section outlines the size of an isolation forest model trained offline for one of the edge devices (baseband unit). The hyper parameters used for training: (1) Raw training dataset: 1,738,395 rows; (2) Number of features: 51; (3) Number of trees: 100; and (4) Sample rate: 50% (869,197 rows). The generated trained model utilized about 20 to 30 MB of RAM when used for inference on an edge device and the RAM budget available for model was in in the order KBs, as the limited RAM allocated for analytics on the device had to be shared by multiple models servicing different applications. As the number of rows and features increase in the training dataset, the RAM requirement grows very quickly beyond ˜100 MB making it almost impossible to deploy it on edge devices without use of the embodiments.

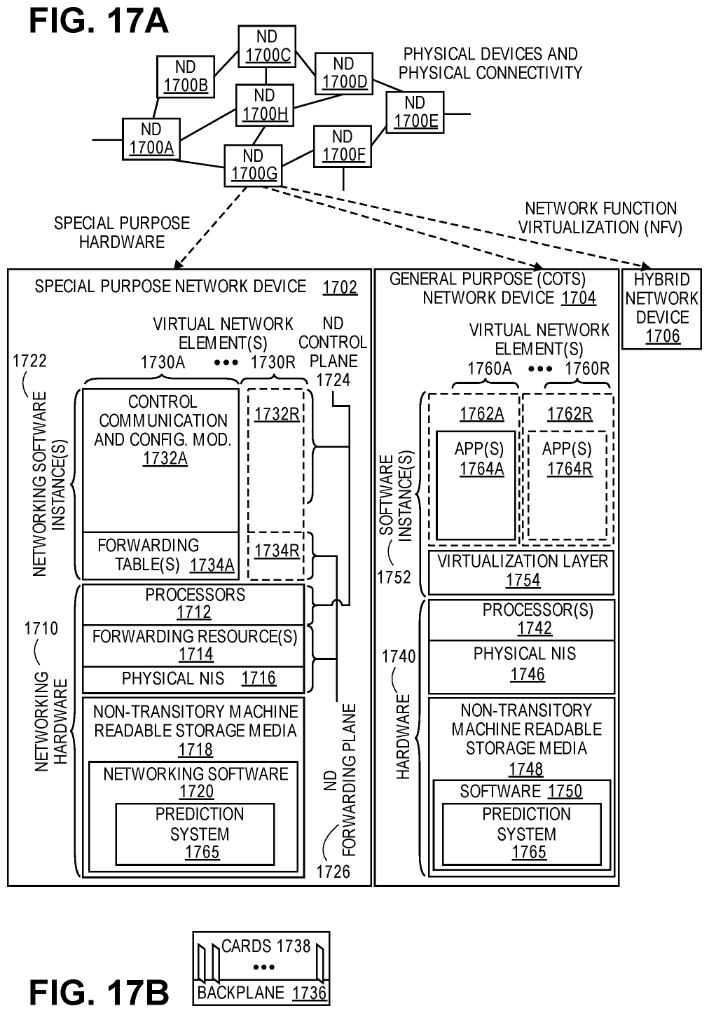

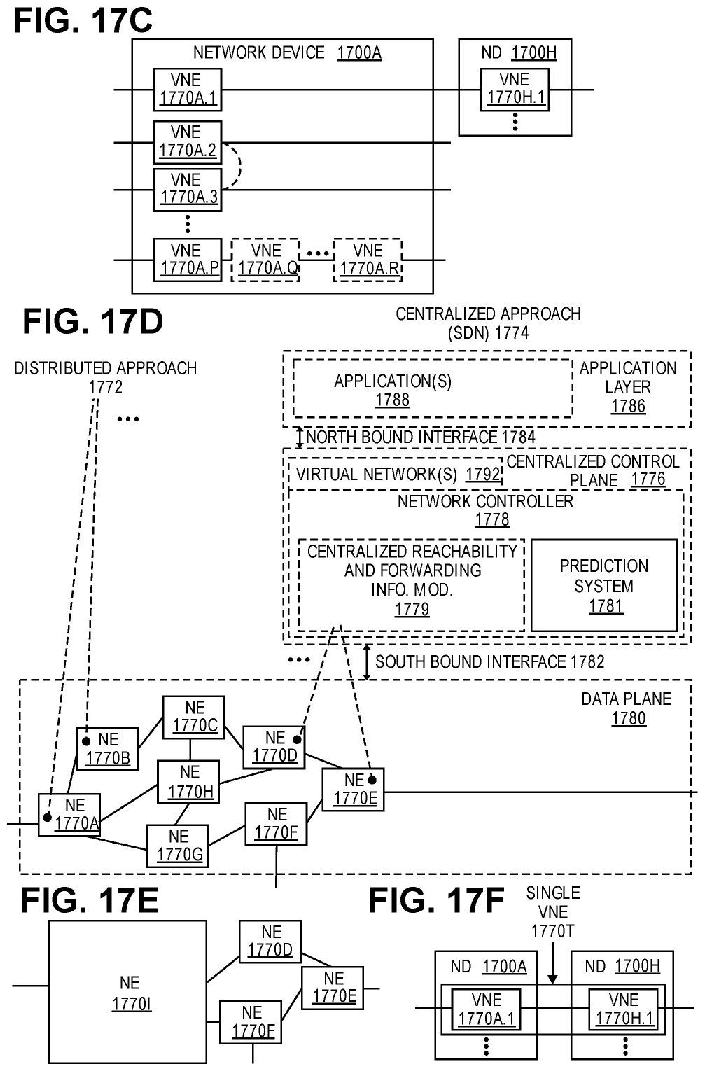

FIG. 17A illustrates connectivity between network devices (NDs) within an exemplary network, as well as three exemplary implementations of the NDs, according to some embodiments of the invention. FIG. 17A shows NDs 1700A-H, and their connectivity by way of lines between 1700A-1700B, 1700B-1700C, 1700C-1700D, 1700D-1700E, 1700E-1700F, 1700F-1700G, and 1700A-1700G, as well as between 1700H and each of 1700A, 1700C, 1700D, and 1700G. These NDs are physical devices, and the connectivity between these NDs can be wireless or wired (often referred to as a link). An additional line extending from NDs 1700A, 1700E, and 1700F illustrates that these NDs act as ingress and egress points for the network (and thus, these NDs are sometimes referred to as edge NDs; while the other NDs may be called core NDs).

Two of the exemplary ND implementations in FIG. 17A are: 1) a special-purpose network device 1702 that uses custom application-specific integrated-circuits (ASICs) and a special-purpose operating system (OS); and 2) a general purpose network device 1704 that uses common off-the-shelf (COTS) processors and a standard OS.

The special-purpose network device 1702 includes networking hardware 1710 comprising a set of one or more processor(s) 1712, forwarding resource(s) 1714 (which typically include one or more ASICs and/or network processors), and physical network interfaces (NIs) 1716 (through which network connections are made, such as those shown by the connectivity between NDs 1700A-H), as well as non-transitory machine readable storage media 1718 having stored therein networking software 1720. During operation, the networking software 1720 may be executed by the networking hardware 1710 to instantiate a set of one or more networking software instance(s) 1722. Each of the networking software instance(s) 1722, and that part of the networking hardware 1710 that executes that network software instance (be it hardware dedicated to that networking software instance and/or time slices of hardware temporally shared by that networking software instance with others of the networking software instance(s) 1722), form a separate virtual network element 1730A-R. Each of the virtual network element(s) (VNEs) 1730A-R includes a control communication and configuration module 1732A-R (sometimes referred to as a local control module or control communication module) and forwarding table(s) 1734A-R, such that a given virtual network element (e.g., 1730A) includes the control communication and configuration module (e.g., 1732A), a set of one or more forwarding table(s) (e.g., 1734A), and that portion of the networking hardware 1710 that executes the virtual network element (e.g., 1730A).

In some embodiments, the networking software 1720 can include the prediction system 1765, which can encompass the model AI functions, the trained ML model, an AI execution engine, and/or the processed described herein. The prediction system 1765 can be executed by the processors 1712 and related components of the device 1702.

The special-purpose network device 1702 is often physically and/or logically considered to include: 1) a ND control plane 1724 (sometimes referred to as a control plane) comprising the processor(s) 1712 that execute the control communication and configuration module(s) 1732A-R; and 2) a ND forwarding plane 1726 (sometimes referred to as a forwarding plane, a data plane, or a media plane) comprising the forwarding resource(s) 1714 that utilize the forwarding table(s) 1734A-R and the physical NIs 1716. By way of example, where the ND is a router (or is implementing routing functionality), the ND control plane 1724 (the processor(s) 1712 executing the control communication and configuration module(s) 1732A-R) is typically responsible for participating in controlling how data (e.g., packets) is to be routed (e.g., the next hop for the data and the outgoing physical NI for that data) and storing that routing information in the forwarding table(s) 1734A-R, and the ND forwarding plane 1726 is responsible for receiving that data on the physical NIs 1716 and forwarding that data out the appropriate ones of the physical NIs 1716 based on the forwarding table(s) 1734A-R.

FIG. 17B illustrates an exemplary way to implement the special-purpose network device 1702 according to some embodiments of the invention. FIG. 17B shows a special-purpose network device including cards 1738 (typically hot pluggable). While in some embodiments the cards 1738 are of two types (one or more that operate as the ND forwarding plane 1726 (sometimes called line cards), and one or more that operate to implement the ND control plane 1724 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 1736 (e.g., a first full mesh coupling the line cards and a second full mesh coupling all of the cards).

Returning to FIG. 17A, the general purpose network device 1704 includes hardware 1740 comprising a set of one or more processor(s) 1742 (which are often COTS processors) and physical NIs 1746, as well as non-transitory machine readable storage media 1748 having stored therein software 1750. During operation, the processor(s) 1742 execute the software 1750 to instantiate one or more sets of one or more applications 1764A-R. While one embodiment does not implement virtualization, alternative embodiments may use different forms of virtualization. For example, in one such alternative embodiment the virtualization layer 1754 represents the kernel of an operating system (or a shim executing on a base operating system) that allows for the creation of multiple instances 1762A-R called software containers that may each be used to execute one (or more) of the sets of applications 1764A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 1754 represents a hypervisor (sometimes referred to as a virtual machine monitor (VMM)) or a hypervisor executing on top of a host operating system, and each of the sets of applications 1764A-R is run on top of a guest operating system within an instance 1762A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 1740, directly on a hypervisor (in which case the unikernel is sometimes described as running within a LibOS virtual machine), or in a software container, embodiments can be implemented fully with unikernels running directly on a hypervisor represented by virtualization layer 1754, unikernels running within software containers represented by instances 1762A-R, or as a combination of unikernels and the above-described techniques (e.g., unikernels and virtual machines both run directly on a hypervisor, unikernels and sets of applications that are run in different software containers).

The instantiation of the one or more sets of one or more applications 1764A-R, as well as virtualization if implemented, are collectively referred to as software instance(s) 1752. Each set of applications 1764A-R, corresponding virtualization construct (e.g., instance 1762A-R) if implemented, and that part of the hardware 1740 that executes them (be it hardware dedicated to that execution and/or time slices of hardware temporally shared), forms a separate virtual network element(s) 1760A-R.

In some embodiments, the software 1750 can include the prediction system 1765, which can encompass the model AI functions, the trained ML model, an AI execution engine, and/or the processed described herein. The prediction system 1765 can be executed by the processors 1742 and related components of the device 1704.

The virtual network element(s) 1760A-R perform similar functionality to the virtual network element(s) 1730A-R—e.g., similar to the control communication and configuration module(s) 1732A and forwarding table(s) 1734A (this virtualization of the hardware 1740 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 1762A-R corresponding to one VNE 1760A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 1762A-R to VNEs also apply to embodiments where such a finer level of granularity and/or unikernels are used.

In certain embodiments, the virtualization layer 1754 includes a virtual switch that provides similar forwarding services as a physical Ethernet switch. Specifically, this virtual switch forwards traffic between instances 1762A-R and the physical NI(s) 1746, as well as optionally between the instances 1762A-R; in addition, this virtual switch may enforce network isolation between the VNEs 1760A-R that by policy are not permitted to communicate with each other (e.g., by honoring virtual local area networks (VLANs)).

The third exemplary ND implementation in FIG. 17A is a hybrid network device 1706, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 1702) could provide for para-virtualization to the networking hardware present in the hybrid network device 1706.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 1730A-R, VNEs 1760A-R, and those in the hybrid network device 1706) receives data on the physical NIs (e.g., 1716, 1746) and forwards that data out the appropriate ones of the physical NIs (e.g., 1716, 1746). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

FIG. 17C illustrates various exemplary ways in which VNEs may be coupled according to some embodiments of the invention. FIG. 17C shows VNEs 1770A.1-1770A.P (and optionally VNEs 1770A.Q-1770A.R) implemented in ND 1700A and VNE 1770H.1 in ND 1700H. In FIG. 17C, VNEs 1770A.1-P are separate from each other in the sense that they can receive packets from outside ND 1700A and forward packets outside of ND 1700A; VNE 1770A.1 is coupled with VNE 1770H.1, and thus they communicate packets between their respective NDs; VNE 1770A.2-1770A.3 may optionally forward packets between themselves without forwarding them outside of the ND 1700A; and VNE 1770A.P may optionally be the first in a chain of VNEs that includes VNE 1770A.Q followed by VNE 1770A.R (this is sometimes referred to as dynamic service chaining, where each of the VNEs in the series of VNEs provides a different service—e.g., one or more layer 4-7 network services). While FIG. 17C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 17A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 17A may also host one or more such servers (e.g., in the case of the general purpose network device 1704, one or more of the software instances 1762A-R may operate as servers; the same would be true for the hybrid network device 1706; in the case of the special-purpose network device 1702, one or more such servers could also be run on a virtualization layer executed by the processor(s) 1712); in which case the servers are said to be co-located with the VNEs of that ND.

A virtual network is a logical abstraction of a physical network (such as that in FIG. 17A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

FIG. 17D illustrates a network with a single network element on each of the NDs of FIG. 17A, and within this straightforward approach contrasts a traditional distributed approach (commonly used by traditional routers) with a centralized approach for maintaining reachability and forwarding information (also called network control), according to some embodiments of the invention. Specifically, FIG. 17D illustrates network elements (NEs) 1770A-H with the same connectivity as the NDs 1700A-H of FIG. 17A.

FIG. 17D illustrates that the distributed approach 1772 distributes responsibility for generating the reachability and forwarding information across the NEs 1770A-H; in other words, the process of neighbor discovery and topology discovery is distributed.

For example, where the special-purpose network device 1702 is used, the control communication and configuration module(s) 1732A-R of the ND control plane 1724 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP), Label Distribution Protocol (LDP), Resource Reservation Protocol (RSVP) (including RSVP-Traffic Engineering (TE): Extensions to RSVP for LSP Tunnels and Generalized Multi-Protocol Label Switching (GMPLS) Signaling RSVP-TE)) that communicate with other NEs to exchange routes, and then selects those routes based on one or more routing metrics. Thus, the NEs 1770A-H (e.g., the processor(s) 1712 executing the control communication and configuration module(s) 1732A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 1724. The ND control plane 1724 programs the ND forwarding plane 1726 with information (e.g., adjacency and route information) based on the routing structure(s). For example, the ND control plane 1724 programs the adjacency and route information into one or more forwarding table(s) 1734A-R (e.g., Forwarding Information Base (FIB), Label Forwarding Information Base (LFIB), and one or more adjacency structures) on the ND forwarding plane 1726. For layer 2 forwarding, the ND can store one or more bridging tables that are used to forward data based on the layer 2 information in that data. While the above example uses the special-purpose network device 1702, the same distributed approach 1772 can be implemented on the general purpose network device 1704 and the hybrid network device 1706.

FIG. 17D illustrates that a centralized approach 1774 (also known as software defined networking (SDN)) that decouples the system that makes decisions about where traffic is sent from the underlying systems that forwards traffic to the selected destination. The illustrated centralized approach 1774 has the responsibility for the generation of reachability and forwarding information in a centralized control plane 1776 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 1776 has a south bound interface 1782 with a data plane 1780 (sometime referred to the infrastructure layer, network forwarding plane, or forwarding plane (which should not be confused with a ND forwarding plane)) that includes the NEs 1770A-H (sometimes referred to as switches, forwarding elements, data plane elements, or nodes). The centralized control plane 1776 includes a network controller 1778, which includes a centralized reachability and forwarding information module 1779 that determines the reachability within the network and distributes the forwarding information to the NEs 1770A-H of the data plane 1780 over the south bound interface 1782 (which may use the OpenFlow protocol). Thus, the network intelligence is centralized in the centralized control plane 1776 executing on electronic devices that are typically separate from the NDs.

For example, where the special-purpose network device 1702 is used in the data plane 1780, each of the control communication and configuration module(s) 1732A-R of the ND control plane 1724 typically include a control agent that provides the VNE side of the south bound interface 1782. In this case, the ND control plane 1724 (the processor(s) 1712 executing the control communication and configuration module(s) 1732A-R) performs its responsibility for participating in controlling how data (e.g., packets) is to be routed (e.g., the next hop for the data and the outgoing physical NI for that data) through the control agent communicating with the centralized control plane 1776 to receive the forwarding information (and in some cases, the reachability information) from the centralized reachability and forwarding information module 1779 (it should be understood that in some embodiments of the invention, the control communication and configuration module(s) 1732A-R, in addition to communicating with the centralized control plane 1776, may also play some role in determining reachability and/or calculating forwarding information—albeit less so than in the case of a distributed approach; such embodiments are generally considered to fall under the centralized approach 1774, but may also be considered a hybrid approach).

While the above example uses the special-purpose network device 1702, the same centralized approach 1774 can be implemented with the general purpose network device 1704 (e.g., each of the VNE 1760A-R performs its responsibility for controlling how data (e.g., packets) is to be routed (e.g., the next hop for the data and the outgoing physical NI for that data) by communicating with the centralized control plane 1776 to receive the forwarding information (and in some cases, the reachability information) from the centralized reachability and forwarding information module 1779; it should be understood that in some embodiments of the invention, the VNEs 1760A-R, in addition to communicating with the centralized control plane 1776, may also play some role in determining reachability and/or calculating forwarding information—albeit less so than in the case of a distributed approach) and the hybrid network device 1706. In fact, the use of SDN techniques can enhance the NFV techniques typically used in the general purpose network device 1704 or hybrid network device 1706 implementations as NFV is able to support SDN by providing an infrastructure upon which the SDN software can be run, and NFV and SDN both aim to make use of commodity server hardware and physical switches.

FIG. 17D also shows that the centralized control plane 1776 has a north bound interface 1784 to an application layer 1786, in which resides application(s) 1788. The centralized control plane 1776 has the ability to form virtual networks 1792 (sometimes referred to as a logical forwarding plane, network services, or overlay networks (with the NEs 1770A-H of the data plane 1780 being the underlay network)) for the application(s) 1788. Thus, the centralized control plane 1776 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

In some embodiments, the application layer 1788 can include the prediction system 1781, which can encompass the model AI functions, the trained ML model, an AI execution engine, and/or the processed described herein. The prediction system 1781 can be executed partially or wholly by the processors of the centralized control plane 1776.

While FIG. 17D shows the distributed approach 1772 separate from the centralized approach 1774, the effort of network control may be distributed differently or the two combined in certain embodiments of the invention. For example: 1) embodiments may generally use the centralized approach (SDN) 1774, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 1774 but may also be considered a hybrid approach.

While FIG. 17D illustrates the simple case where each of the NDs 1700A-H implements a single NE 1770A-H, it should be understood that the network control approaches described with reference to FIG. 17D also work for networks where one or more of the NDs 1700A-H implement multiple VNEs (e.g., VNEs 1730A-R, VNEs 1760A-R, those in the hybrid network device 1706). Alternatively, or in addition, the network controller 1778 may also emulate the implementation of multiple VNEs in a single ND. Specifically, instead of (or in addition to) implementing multiple VNEs in a single ND, the network controller 1778 may present the implementation of a VNE/NE in a single ND as multiple VNEs in the virtual networks 1792 (all in the same one of the virtual network(s) 1792, each in different ones of the virtual network(s) 1792, or some combination). For example, the network controller 1778 may cause an ND to implement a single VNE (a NE) in the underlay network, and then logically divide up the resources of that NE within the centralized control plane 1776 to present different VNEs in the virtual network(s) 1792 (where these different VNEs in the overlay networks are sharing the resources of the single VNE/NE implementation on the ND in the underlay network).

On the other hand, FIGS. 17E and 17F respectively illustrate exemplary abstractions of NEs and VNEs that the network controller 1778 may present as part of different ones of the virtual networks 1792. FIG. 17E illustrates the simple case of where each of the NDs 1700A-H implements a single NE 1770A-H (see FIG. 17D), but the centralized control plane 1776 has abstracted multiple of the NEs in different NDs (the NEs 1770A-C and G-H) into (to represent) a single NE 1770I in one of the virtual network(s) 1792 of FIG. 17D, according to some embodiments of the invention. FIG. 17E shows that in this virtual network, the NE 1770I is coupled to NE 1770D and 1770F, which are both still coupled to NE 1770E.

FIG. 17F illustrates a case where multiple VNEs (VNE 1770A.1 and VNE 1770H.1) are implemented on different NDs (ND 1700A and ND 1700H) and are coupled to each other, and where the centralized control plane 1776 has abstracted these multiple VNEs such that they appear as a single VNE 1770T within one of the virtual networks 1792 of FIG. 17D, according to some embodiments of the invention. Thus, the abstraction of a NE or VNE can span multiple NDs.

While some embodiments of the invention implement the centralized control plane 1776 as a single entity (e.g., a single instance of software running on a single electronic device), alternative embodiments may spread the functionality across multiple entities for redundancy and/or scalability purposes (e.g., multiple instances of software running on different electronic devices).

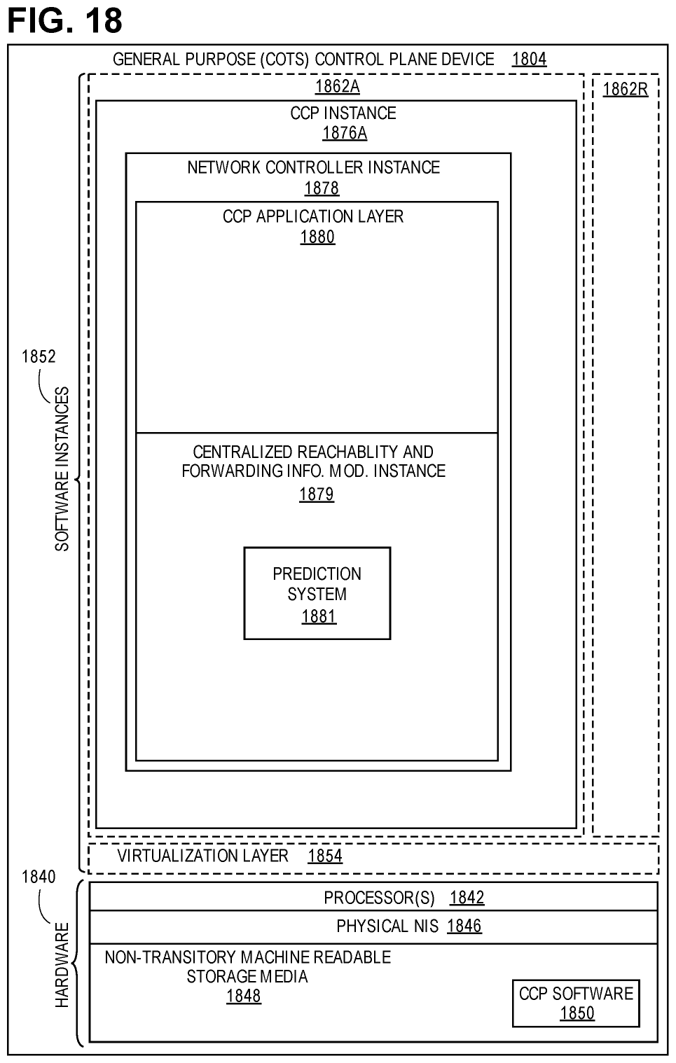

Similar to the network device implementations, the electronic device(s) running the centralized control plane 1776, and thus the network controller 1778 including the centralized reachability and forwarding information module 1779, may be implemented a variety of ways (e.g., a special purpose device, a general-purpose (e.g., COTS) device, or hybrid device). These electronic device(s) would similarly include processor(s), a set of one or more physical NIs, and a non-transitory machine-readable storage medium having stored thereon the centralized control plane software. For instance, FIG. 18 illustrates, a general purpose control plane device 1804 including hardware 1840 comprising a set of one or more processor(s) 1842 (which are often COTS processors) and physical NIs 1846, as well as non-transitory machine readable storage media 1848 having stored therein centralized control plane (CCP) software 1850.

In some embodiments, the non-transitory machine-readable medium 1848 can include the prediction system 1881, which can encompass the model AI functions, the trained ML model, an AI execution engine, and/or the processed described herein. The prediction system 1881 can be executed partially or wholly by the processors 1842.

In embodiments that use compute virtualization, the processor(s) 1842 typically execute software to instantiate a virtualization layer 1854 (e.g., in one embodiment the virtualization layer 1854 represents the kernel of an operating system (or a shim executing on a base operating system) that allows for the creation of multiple instances 1862A-R called software containers (representing separate user spaces and also called virtualization engines, virtual private servers, or jails) that may each be used to execute a set of one or more applications; in another embodiment the virtualization layer 1854 represents a hypervisor (sometimes referred to as a virtual machine monitor (VMM)) or a hypervisor executing on top of a host operating system, and an application is run on top of a guest operating system within an instance 1862A-R called a virtual machine (which in some cases may be considered a tightly isolated form of software container) that is run by the hypervisor; in another embodiment, an application is implemented as a unikernel, which can be generated by compiling directly with an application only a limited set of libraries (e.g., from a library operating system (LibOS) including drivers/libraries of OS services) that provide the particular OS services needed by the application, and the unikernel can run directly on hardware 1840, directly on a hypervisor represented by virtualization layer 1854 (in which case the unikernel is sometimes described as running within a LibOS virtual machine), or in a software container represented by one of instances 1862A-R). Again, in embodiments where compute virtualization is used, during operation an instance of the CCP software 1850 (illustrated as CCP instance 1876A) is executed (e.g., within the instance 1862A) on the virtualization layer 1854. In embodiments where compute virtualization is not used, the CCP instance 1876A is executed, as a unikernel or on top of a host operating system, on the “bare metal” general purpose control plane device 1804. The instantiation of the CCP instance 1876A, as well as the virtualization layer 1854 and instances 1862A-R if implemented, are collectively referred to as software instance(s) 1852.

In some embodiments, the CCP instance 1876A includes a network controller instance 1878. The network controller instance 1878 includes a centralized reachability and forwarding information module instance 1879 (which is a middleware layer providing the context of the network controller 1778 to the operating system and communicating with the various NEs), and an CCP application layer 1880 (sometimes referred to as an application layer) over the middleware layer (providing the intelligence required for various network operations such as protocols, network situational awareness, and user-interfaces). At a more abstract level, this CCP application layer 1880 within the centralized control plane 1776 works with virtual network view(s) (logical view(s) of the network) and the middleware layer provides the conversion from the virtual networks to the physical view.

The centralized control plane 1776 transmits relevant messages to the data plane 1780 based on CCP application layer 1880 calculations and middleware layer mapping for each flow. A flow may be defined as a set of packets whose headers match a given pattern of bits; in this sense, traditional IP forwarding is also flow-based forwarding where the flows are defined by the destination IP address for example, however, in other implementations, the given pattern of bits used for a flow definition may include more fields (e.g., 10 or more) in the packet headers. Different NDs/NEs/VNEs of the data plane 1780 may receive different messages, and thus different forwarding information. The data plane 1780 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 1780, the packet (or a subset of the packet header and content) is typically forwarded to the centralized control plane 1776. The centralized control plane 1776 will then program forwarding table entries into the data plane 1780 to accommodate packets belonging to the flow of the unknown packet. Once a specific forwarding table entry has been programmed into the data plane 1780 by the centralized control plane 1776, the next packet with matching credentials will match that forwarding table entry and take the set of actions associated with that matched entry.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes, where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

For example, while the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method for generating a prediction in a low resource device using a decision tree based machine learning model, the method comprising:
receiving an input for a prediction request;
selecting a first tree from the machine learning model;
selecting and loading a first node from the first tree into working memory;
accumulating a result from the first node;
releasing the first node from working memory; and
selecting and loading a second node from the first tree into working memory.

2. The method of claim 1, further comprising:
determining a number of trees in the machine learning model; and
dividing the result by the number of trees.

3. The method of claim 1, wherein the result is a path length in at least the first tree.

4. The method of claim 1, wherein a single node of the selected tree is allotted working memory at a given time.

5. The method of claim 1, further comprising:
accumulating the result from the second node.

6. The method of claim 1, wherein the machine learning model is an isolation forest model.

7. A non-transitory machine-readable medium comprising computer program code which when executed by a computer carries out a set of operations of a method for generating a prediction in a low resource device using a decision tree based machine learning model, the set of operations comprising:
receiving input for a prediction request;
selecting a first tree from the machine learning model;
selecting and loading a first node from the first tree into working memory;
accumulating a result from the first node;
releasing the first node from working memory; and
selecting and loading a second node from the first tree into working memory.

8. The non-transitory machine-readable medium of claim 7, the set of operations further comprising:
determining a number of trees in the machine learning model; and
dividing the result by the number of trees.

9. The non-transitory machine-readable medium of claim 7, wherein the result is a path length in at least the first tree.

10. The non-transitory machine-readable medium of claim 7, wherein a single node of the selected tree is allotted working memory at a given time.

11. The non-transitory machine-readable medium of claim 7, the set of operations further comprising:
accumulating the result from the second node.

12. An electronic device comprising:
a machine-readable medium having stored therein an anomaly detector; and
a processor coupled to the machine-readable medium, the processor to execute the anomaly detector to perform a method for generating a prediction in a low resource device using a decision tree based machine learning model, the anomaly detector to receive input for a prediction request, select a first tree from the machine learning model, select and load a first node from the first tree into working memory, accumulate a result from the first node, release the first node from working memory, and select and load a second node from the first tree into working memory.

13. The electronic device of claim 12, the anomaly detector to further determine a number of trees in the machine learning model, and divide the result by the number of trees.

14. The electronic device of claim 12, wherein the result is a path length in at least the first tree.

15. The electronic device of claim 12, wherein a single node of the selected tree is allotted working memory at a given time.

16. The electronic device of claim 12, the anomaly detector to further accumulate the result from the second node.
